(19) United States
(12) Patent Application Publication
(10) Pub. No.: US 2006/0064681 A1
(43) Pub. Date: Mar. 23, 2006

(54) Method and system for verifying makefile accuracy

(76) Inventor: Douglas Brent Robinson, Hollis, NH (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/947,221

(22) Filed: Sep. 23, 2004

(51) Int. Cl. G06F 9/45

(52) U.S. Cl. 717/141

(57) ABSTRACT

A method and system are described for verifying makefile accuracy. According to an exemplary embodiment, a method is described for verifying the accuracy of a make file associated with building a target object. The method includes identifying dependencies for building the target object based on information included in the makefile. Elements used in building the target object are determined. A determination is made whether a disparity exists between the elements used in building the target object and the identified dependencies. Existing disparities between the determined elements and the identified dependencies are reported.

### BACKGROUND

Early software products used simple machine languages or code to control the operation of a processor, or used simple interpreted languages to perform some function or task. Machine languages had the advantage of being optimized for a particular type of processor, and as such produced efficient software routines. But the specialized forms of the machine languages and the difficulty in porting programs developed with such languages to other platforms have proved limiting. Interpreted languages can be designed to be easy to program and understand, but generally produce programs that are less efficient than machine-language-based programs.

As machines and tasks became more complex, so too did the languages used to create the software for controlling them. Among the more complex languages developed were a number of compiled languages including Fortran, Pascal, and C. Compiled-language software programs use an input format, referred to as source code, that can be as readily understood as programs written in interpreted languages. The source code is compiled into an executable program of machine code that is specific to the particular platform on which the program will be run. As such, compiled-language programs can be as efficient as true machine-language-based programs, but have the advantage of being portable to other platforms simply by re-compiling the program's source code on the new platform.

Creating a compiled-language program typically involves compiling and linking together several files of source code and other information, such as library objects, in a particular sequence. Early on in the development of compiled-language programs, platforms, such as UNIX, included a program called “make” to facilitate the compilation process. The make program uses a description file, typically named “makefile”, that defines the source files and commands needed to build an executable object or program of a platform.

The UNIX make program, or a suitable equivalent thereof, has been ported to most operating system (OS) platforms. While the general function of the make program is the same across these different platforms, differences in the OS and in the particular make programs themselves can cause source code to be compiled or built differently on the various platforms. The differences can result from the manner in which a particular OS or make program interprets the information specified in a program's makefile. For example, the make program implemented on a particular platform may be successful in building an executable program even though some of the source code files or commands specified in the corresponding makefile are ambiguous or incorrect. But the program may not build successfully on other platforms, because the target OS's are unable to resolve the ambiguities or errors in the makefile. Identifying such ambiguities and errors in a makefile prior to its use on an OS can better ensure that an executable program will be successfully built on the target OS.

### SUMMARY

Accordingly, a method and system are described for verifying makefile accuracy. According to an exemplary embodiment, a method is described for verifying the accuracy of a makefile associated with building a target object. The method includes identifying dependencies for building the target object based on information included in the makefile. Elements used in building the target object are determined. A determination is made whether a disparity exists between the elements used in building the target object and the identified dependencies. Existing disparities between the determined elements and the identified dependencies are reported.

According to another exemplary embodiment, a system is described for verifying the accuracy of a makefile associated with building a target object. The system includes memory configured to store information, including the makefile, for building the target object, the information representing a build environment for the target object. A processor is coupled to the memory, and includes logic configured to identify dependencies within the build environment for building the target object, the identification based on information included in the makefile. Additional logic is configured to determine elements included in the build environment used in building the target object. The processor further includes logic configured to determine if a disparity exists between the elements used in building the target object and the identified dependencies. Logic is also configured to report existing disparities between the determined elements and the identified dependencies.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 is a flowchart illustrating a method for verifying makefile accuracy, according to an exemplary embodiment;

FIGS. 2A and 2B illustrate a system for verifying makefile accuracy and corresponding makefile, according to an exemplary embodiment; and

FIGS. 3A-3C illustrate exemplary information generated using the system of FIG. 2A for verifying makefile accuracy.

### DETAILED DESCRIPTION

Various aspects will now be described in connection with exemplary embodiments, including certain aspects described in terms of sequences of actions that can be performed by elements of a computer system. For example, it will be recognized that in each of the embodiments, the various actions can be performed by specialized circuits or circuitry (e.g., discrete and/or integrated logic gates interconnected to perform a specialized function), by program instructions being executed by one or more processors, or by a combination of both.

Thus, the various aspects can be embodied in many different forms, and all such forms are contemplated to be within the scope of what is described. For each of the various aspects, any such form of embodiment can be referred to here as “logic configured to” perform, or “logic that” performs a described action.

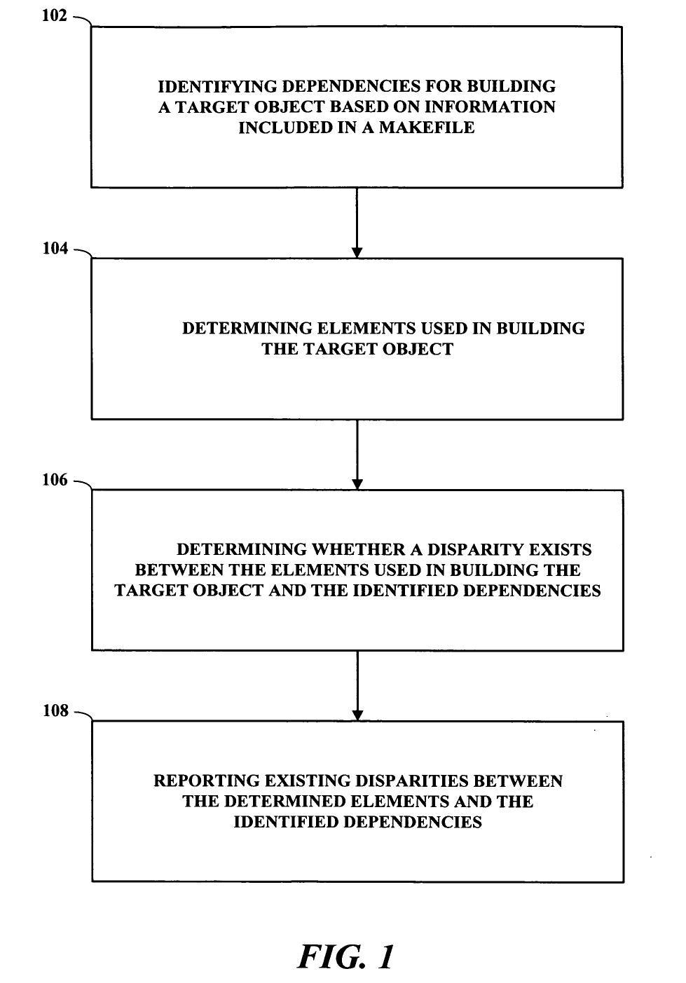

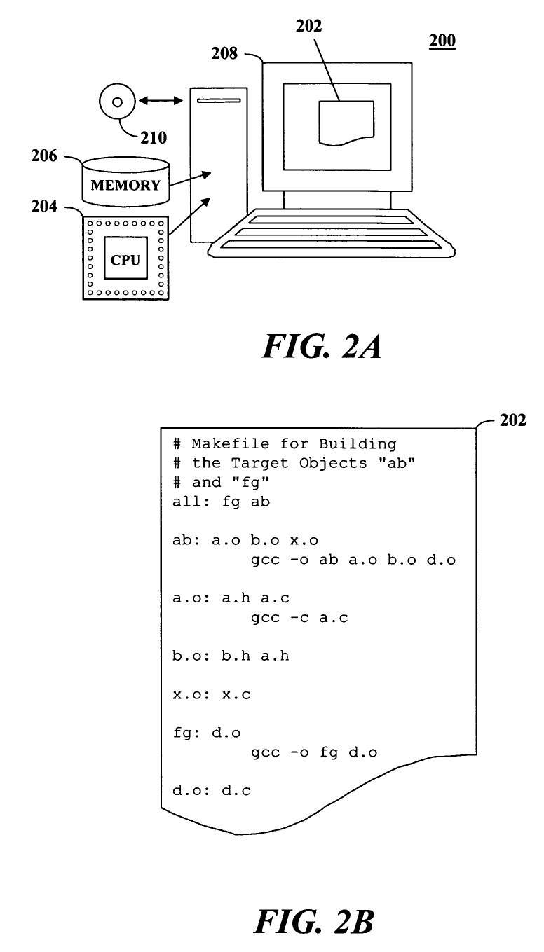

FIG. 1 depicts a flowchart illustrating an exemplary method for verifying the accuracy of a makefile associated with building a target object. The method can be carried out using the exemplary system 200 depicted in FIG. 2A, portions of which are referenced in the description of the method for illustration purposes. As used here, an object can include software and, in particular, can include a compiled module, executable on a general purpose processor for performing a particular task. The object can be built from various source code elements and/or by linking together other subcomponent object elements. The source code elements can be defined in any suitable language, such as C++, and can be compiled into object modules using an appropriate compiler, e.g., the GNU C++ compiler gcc. The phrase “target object” is used here merely to identify a particular object being built, and in particular to identify a top-level object module or executable program, but otherwise refers to an object as defined above. As described below, a makefile can define the creation of several “targets” when building the top-level object or executable program.

As described above, a makefile can be a description file or recipe used by the make program to build an object or executable program. The make program is available in most, if not all, build environments. The phrase “build environment” is used here to refer to a collection of information that can be used to compile, link, and build objects. The build environment can include, among many other items of information, source code, object modules, and programs, such as make, for building a target object.

Makefiles typically have several components including comments, dependency statements, directives, macros, response files, rules and command lines. A relatively simple, exemplary makefile 202 is shown in FIG. 2B. Dependency statements are used to explicitly declare the dependencies of a target object, and are of the form “<target>: <dependency list>”. For example, the makefile shown in FIG. 2B includes seven dependency statements, the first of which is “all: fg ab”. This statement defines that the target object “all” has two declared dependencies, “fg” and “ab”. In the second dependency statement, “ab: a.o b.o x.o”, “ab” is a target object, and the subcomponent object elements “a.o”, “b.o”, and “x.o” are the declared dependencies of the target “ab”. The indented lines that follow each dependency statement are called command lines. Command lines instruct make how to build the corresponding target. For example, the command line “gcc -o ab a.o b.o d.o” is an instruction to invoke the GNU C-complier to build the object “ab” from the object modules “a.o”, “b.o, and “d.o”.

Although different build environments can have slightly different implementations of the make program, make generally operates in the following manner. First, the make program finds a target in the description file (or makefile). For example, in the makefile 202 shown in FIG. 2B, make can find the target “ab”. Make can then recursively execute on all of the dependencies of the found target that are themselves targets (or sub-targets), verifying that all of a target's dependencies exist and have a modification date early then the respective target. If a dependency is found to have a later modification date, the corresponding target's command lines are executed to build/rebuild the target. The process continues until all dependencies have been verified and their corresponding targets have been built, if required.

In block 101 of the exemplary method shown in FIG. 1, dependencies for building a target object based on information included in a makefile are determined. For example, means for identifying the dependencies can include the processor 204 of the system 200 for verifying makefile accuracy as shown in FIG. 2A. The means can also include memory 206, coupled to the processor 204, configured to store information, including the makefile, the make program, source files, libraries, and the like, to form the build environment suitable for building the target object. The processor 204 and memory 206 can be embodied in a personal computing system 200 such as that shown in the figure.

Logic included in the processor 204 can perform a process similar to that performed by the make program itself to identify the dependencies for building the target object based on information included in the makefile. For example, the processor logic can be configured to parse the information included in the makefile 202 to identify the target object, e.g., the target “ab” shown in the makefile 202 of FIG. 2B. The processor logic can then be configured to recursively identify dependencies of the target object declared in the makefile to create a list of declared target object dependencies.

Consider, for example, the makefile 202 shown in FIG. 2B. The logic configured to identify dependencies can first parse the makefile 202 to identify the target “ab” included in the dependency statement “ab: a.o b.o x.o”. The processor logic can then recursively identify dependencies of the target object declared in the makefile 202 starting with the dependencies “a.o”, “b.o”, and “x.o”. For example, the processor logic can further parse the makefile 202 to determine the dependencies the subcomponent “a.o”. As shown in the exemplary makefile 202, a dependency statement for “a.o” explicitly declares the dependencies “a.h” and “a.c”, which will be understood by those skilled in the art to be the respective header and source code files of the subcomponent object “a.o”. Further parsing of the makefile 202 by the processor logic indicates that no dependencies for either “a.h” and “a.c” are explicitly declared in the makefile 202.

The processor logic can then parse the makefile 202 to determine the dependencies of the subcomponent “b.o”. As shown in the exemplary makefile 202, a dependency statement for the subcomponent “b.o” explicitly declares the dependencies “b.h” and “a.h”. Although not explicitly declared in the makefile 202, persons skilled in the art will understand that the make program will search for the source code file “b.c” in the build environment, and use this file along with the header files “b.h” and “a.h” to build the subcomponent object “b.o”. Since “b.c” is not explicitly declared in the makefile 202 but is used in building the subcomponent object “b.o”, the dependency is referred to here as an implicit declaration. Various make programs can include rules that allow for the implicit declaration of dependencies of target objects in a makefile.

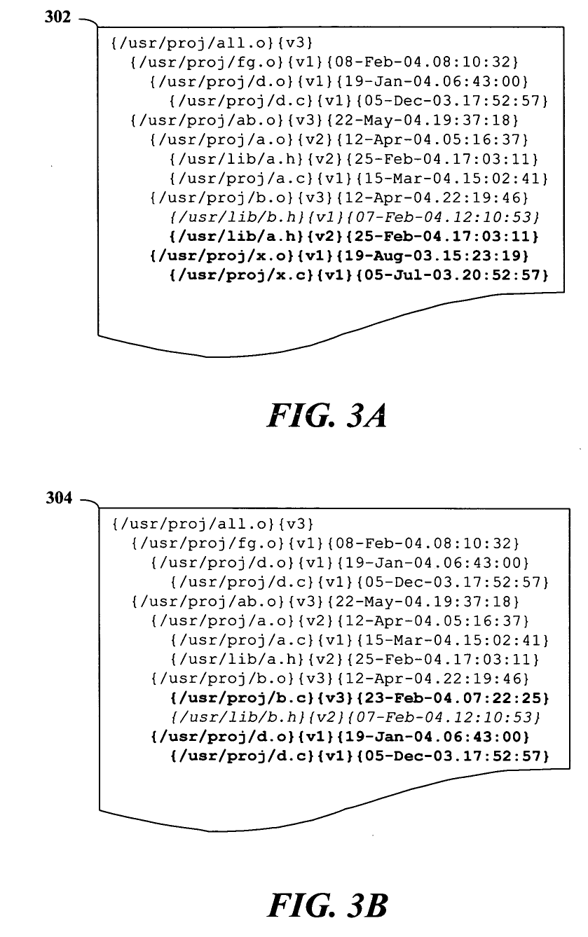

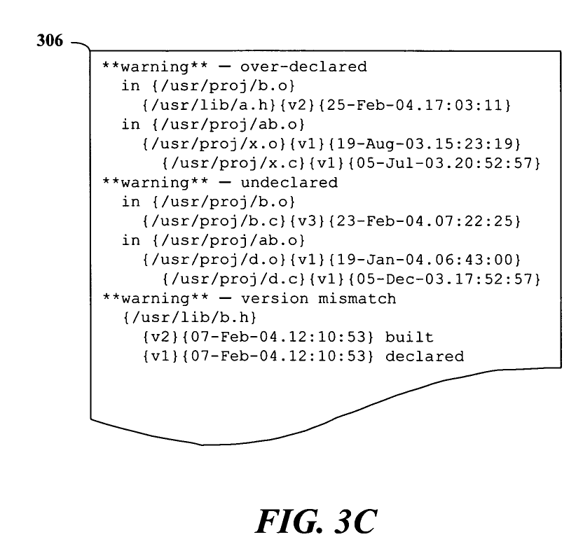

Further parsing of the makefile 202 by the processor logic again indicates that no dependencies for either “b.h” or “a.h” are explicitly declared in the makefile 202. The processor logic can next parse the makefile 202 to determine the dependencies of the subcomponent “x.o”. Recursive processing of the makefile 202 by the processor logic to identify dependencies of the target object as described above can result in the creation of a list of declared target object dependencies, such as the list 302 shown in FIG. 3A. As can be seen in the figure, each dependency, e.g., “a.o”, “a.h”, “a.c”, “b.o”, . . . , declared in the makefile 202 to be used by the make program to build the target “ab” is included in the exemplary list 302.

The list can include other information about the identified declared dependencies, such as a location, a version, and a time of creation. For example, the identifier of the declared dependency “a.h”, included as the third entry in the exemplary list 302, can include additional information to identify a location of the dependency within the build environment, such as a directory pathname “/usr/lib/” as shown. The identifier can also include information to identify a version of the dependency, such as a version_id “v2” as shown. The identifier can also include information to identify a time that the dependency was last built, such as a timestamp “25-Feb-04.17:03:11”.

The different types of information included in an identifier, such as the location, version, and timestamp, can be incorporated into a memory-based or file-based structure. The different portions of the identifier can be delimited between special characters, such as “{ } ” (as shown in FIGS. 3A-3C) or “, ,” Alternatively, the identifier can be concatenated string with different portions of the identifier being separated by using special characters, such as the “_” character. The special characters can be used by the processor logic to aid in parsing the information included in the list. The list can be stored in memory, and in particular can be stored in a file within the build environment.

In block 104 of the exemplary method, elements used in building the target object are identified. Means for identifying the elements used in building the target object can include logic configured to identify elements referenced or created during the building of the target object when the elements are referenced or created. For example, the make program itself can be modified to monitor and record each time a file in the build environment is created, opened, read, and the like, during the build process to identify the elements actually used (or at least referenced) in building the target object. Identities of elements referenced during the building of the target object can be used to create a list of elements used in building the target object, such as the list 304 shown in FIG. 3B. The elements identified in the list can again include other information about the identified elements, such as a location, a version, and a time of creation of the element referenced.

Another approach to identify the elements used in building the target object can be to create intercept routines for the various OS calls used by the make program to open, create (or link), and unlink elements in the build environment. An intercept routine is a program that executes code in place of (or “intercepts”) a standard OS call, such as an OPEN, CREATE, or UNLINK OS call. Typically, the intercept routine can call or execute the code of the standard OS call in addition to other instructions for performing a particular added function. Using this approach, the “other instructions” in the intercept routine(s) can be used to identify the elements referenced during the particular OS call intercepted, e.g., OPEN, CREATE, or UNLINK, and to create the appropriate list 304 of identifiers for these elements and store the list 304 in the build environment, e.g., in a memory-based or file-based structure or in a file. The intercepted routine(s) can be referenced in an environment variable, e.g., the LD_PRELOAD environment variable in a UNIX-based system, to provide the make program with access to the intercept routine(s).

According to an exemplary embodiment, the elements referenced or created when building the target object can be identified while building a subcomponent used in building the target object. For example, in the exemplary makefile 202, the subcomponents “a.o”, “b.o”, and “x.o” are used to build the target object “ab”. The elements used to build these subcomponents, e.g., “a.c”, “a.h”, “b.c”, “b.h”, and “x.c” can be identified when their corresponding subcomponent target objects “a.o”, “b.o”, and “x.o” are being built. The elements identified during the building of the subcomponents can be associated with their respective subcomponents.

For example, information regarding the elements used to build a particular subcomponent can be stored in the memory 206 in, perhaps, a file associated with the particular subcomponent. Then, if during the building of the target object a particular subcomponent does not need to be rebuilt, the contents of the file associated with subcomponent can be included in the list used to identify elements used in building the target object. A particular subcomponent may not need to be rebuilt when the dependency files for the subcomponent have not changed since the last build of the subcomponent. This can be a feature of the particular make program being used to build the target object, and can based on a combination of the version and timestamp associated with particular elements.

In block 106, a determination is made whether a disparity exists between the elements used in building the target object and the identified dependencies. For example, means for comparing the elements used in building the target object with the identifying dependencies can include processor logic configured to compare the list 304 of elements used in building the target object with the list 302 of target object dependencies declared in the makefile 202.

The processor logic can be configured to determine whether all target object dependencies declared in the makefile correspond to elements used in building the target object. For example, the processor 204 can further analyze and compare files corresponding to the lists 302, 304 to determine that the element “a.h”, having the entry “{/usr/lib/a.h}{v2}{25-Feb-04.17:03:11}” in the list 302 (shown in bold type in FIG. 3A) was not referenced during the building of the target object, as no corresponding entry exists after the entry corresponding to “b.o” in the list 304 shown in FIG. 3B. Note that there is an entry for “a.h” in the list 302, but the processor logic can be configured to determine that this entry corresponds to the building of “a.o” not “b.o”. Similarly, the processor 204 can determine that the elements “x.o” and “x.c”, having the respective entries “{/usr/proj/x.o}{v1}{19-Aug-03.15:23:19}” and “{/usr/proj/x.c}{v1}{05-Jul-03.20:52:57}” in the list 302 (again shown in bold type in FIG. 3A) were not referenced during the building of the target object “ab”, as no corresponding entries exist in the list 304 shown in FIG. 3B.

The processor logic can be configured to determine whether all elements used in building the target object correspond to target object dependencies declared in the makefile 202. For example, if the information included in the lists 302 and 304 is stored in corresponding files of the memory 206, the processor 204 can analyze and compare these files to determine that the element “b.c”, having the entry “{/usr/proj/b.c}{v3}{23-Feb-04.07:22:25}” in the list 304 (shown in bold type in FIG. 3B) does not have a corresponding entry in the list 302 shown in FIG. 3A. No corresponding entry for “b.c” exists in the list 302 because the source file is not explicitly declared in the dependency statement for the target b.o in the makefile 202. Recall that the make program can include rules that allow dependencies to be implicitly declared (i.e., not explicitly stated) in the makefile 202, but still used in the building of a target object.

Similarly, the processor 204 can determine that the elements “d.o” and “d.c”, having the respective entries “{/usr/proj/d.o}{v1}{19-Jan-04.06:43:00}” and {/usr/proj/d.c}{v1}{05-Dec-03.17:52:57}” in the list 304 (again shown in bold type in FIG. 3B), which were referenced during the building of the target object “ab”, were not explicitly declared in the makefile 202, as no corresponding entries exist in the list 302 shown in FIG. 3A. Note again that an entry for “d.o” does exist in the list 302, but the processor logic 204 can determine that this entry corresponds to the explicit declaration for the target object “fg”, not for the target “ab”. Indeed, it is because the object “d.o” was built during the building of the target “fg” that the subcomponent “d.o” was available for use in the building of the target “ab”. Note that the entry in the list 304 for “d.o”, e.g., “{/usr/proj/d.o}{v1}{19-Jan-04.06:43:00}” corresponds to the same element built during the building of the target “fg”.

Additional processor logic can be configured to determine whether a version of each element used in building the target object matches a version of a corresponding target object dependency declared in the makefile. Unique identifiers within the build environment can be used to identify a version of each element used in building the target object. For example, the processor 204 can further analyze and compare files corresponding to the lists 302, 304 to determine that the version_id of element “b.h”, having the entry “{/usr/lib/b.h}{v2}{07-Feb-04.12:10:53}” in the list 304 (shown in italics in FIG. 3B), is different than version_id of the corresponding declared dependency in the list 302 (“v2” versus v1”), having the entry “{/usr/lib/b.h}{v1}{07-Feb-04.12:10:53}” (again shown in italics in FIG. 3A). While it is unlikely that two different versions of the same element would have identical timestamps, as shown in the example, the unique identifiers can be used within the build environment to distinguish between such elements if, for example, the different versioned elements where built in parallel to one another and were assigned the same timestamp.

In block 108, existing disparities between the determined elements and the identified dependencies are reported. Means for reporting the disparities can include the processor 204, memory 206, and a monitor 208, coupled to the processor and memory, configured to display the disparities to a user. The processor logic can be configured to report target object dependencies declared in the makefile that do not correspond to elements used in building the target object as over-declared dependencies. For example, the output file 306 shown in FIG. 3C can include a warning identifying that the element “a.h” is over-declared in the dependency statement for the subcomponent “b.o”. Similarly, warnings can be included in the list 306 identifying that the elements “x.o” and “x.c” are over-declared in the dependency statement for the target “ab”.

The processor 204 can also include logic configured to report elements used in building the target object that do not correspond to target object dependencies declared in the makefile as undeclared (e.g., implicit) dependencies. For example, the processor 204 can generate a warning in an output file 306, as shown in FIG. 3C, that is displayable on the monitor 208. The output file 306 can identify undeclared elements referenced during the build process, such as the element “b.c”, which can be referenced during the build of the subcomponent “b.o”, but not explicitly declared in the makefile 202. Similarly, warnings can be included in the list 306 identifying that the elements “d.o” and “d.c” were referenced during the building of the target “ab”, but were not declared in the target's dependency statement. Recall that although the element “d.o” is not explicitly declared for the target “ab”, the element is available for the building of the target “ab” as a result of being built as an explicitly declared dependency of the earlier-built target “fg”.

Additional logic can be included to report when a version of any element used in building the target object does not match a version of a corresponding target object dependency declared in the makefile. For example, the output file 306 includes a warning identifying that a different version of the element “b.h” was used in building the target object “ab” than the version identified when the makefile 202 was parsed. This could result if, for example, a parallel process created a newer version of “b.h” during the building of the target object “ab”.

The executable instructions of a computer program as illustrated in FIG. 1 for verifying makefile accuracy can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used here, a “computer readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium, such as the removable storage device 210 shown in FIG. 2A. More specific examples (a non exhaustive list) of the computer readable medium can include the following: an electrical connection having one or more wires, a portable computer diskette, a random access memory (RAM), a read only memory (ROM), an erasable programmable read only memory (EPROM or Flash memory), an optical fiber, and a portable compact disc read only memory (CDROM).

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for verifying the accuracy of a makefile associated with building a target object, the method comprising:
identifying dependencies for building the target object based on information included in the makefile;
determining elements used in building the target object;
determining whether a disparity exists between the elements used in building the target object and the identified dependencies; and
reporting existing disparities between the determined elements and the identified dependencies.

2. The method of claim 1, wherein identifying dependencies for building the target object comprises:
parsing the makefile to identify the target object; and
recursively identifying dependencies of the target object declared in the makefile to create a list of declared target object dependencies.

3. The method of claim 1, wherein determining elements used in building the target object comprises:
identifying elements referenced or created during the building of the target object when the elements are referenced or created to create a list of elements used in building the target object.

4. The method of claim 3, wherein determining elements used in building the target object comprises:
identifying elements referenced or created while building a subcomponent used in building the target object;
associating the elements identified while building the subcomponent with the corresponding subcomponent; and
including the elements associated with the subcomponent in the list of elements when the subcomponent is used in building the target object

5. The method of claim 1, comprising:
comparing a list of elements used in building the target object with a list of target object dependencies declared in the makefile.

6. The method of claim 5, wherein determining whether a disparity exists between the elements used in building the target object and the identified dependencies comprises:
determining whether all elements used in building the target object correspond to target object dependencies declared in the makefile; and
determining whether all target object dependencies declared in the makefile correspond to elements used in building the target object.

7. The method of claim 1, comprising:
using respective unique identifiers to identify a version of each element used in building the target object.

8. The method of claim 7, wherein determining whether a disparity exists between the elements used in building the target object and the identified dependencies comprises:
determining whether a version of each element used in building the target object matches a version of a corresponding target object dependency declared in the makefile using the respective identifiers.

9. The method of claim 1, wherein reporting existing disparities between the determined elements and the identified dependencies comprises at least one of:
reporting elements used in building the target object that do not correspond to target object dependencies declared in the makefile as implicit dependencies;
reporting target object dependencies declared in the makefile that do not correspond to elements used in building the target object as over-declared dependencies; and
reporting when a version of any element used in building the target object does not match a version of a corresponding target object dependency declared in the makefile.

10. A system for verifying the accuracy of a makefile associated with building a target object, the system comprising:
memory configured to store information, including the makefile, for building the target object, the information representing a build environment for the target object; and
a processor coupled to the memory, the processor including
logic configured to identify dependencies within the build environment for building the target object, the identification based on information included in the makefile;
logic configured to determine elements included in the build environment used in building the target object;
logic configured to determine if a disparity exists between the elements used in building the target object and the identified dependencies; and
logic configured to report existing disparities between the determined elements and the identified dependencies.

11. The system of claim 10, wherein the logic configured to identify dependencies for building the target object comprises:
logic configured to parse the makefile to identify the target object; and
logic configured to recursively identify dependencies of the target object declared in the makefile to create a list of declared target object dependencies.

12. The system of claim 10, wherein the logic configured to determining elements used in building the target object comprises:
logic configured to identify elements referenced or created during the building of the target object when the elements are referenced or created to create a list of elements used in building the target object.

13. The system of claim 12, wherein the logic configured to determine elements used in building the target object comprises:
logic configured to identify elements referenced or created while building a subcomponent included in the build environment, the subcomponent used in building the target object;
logic configured to associate the elements identified while building the subcomponent with the corresponding subcomponent; and
logic configured to include the elements associated with the subcomponent in the list of elements when the subcomponent is used in building the target object

14. The system of claim 10, wherein the processor comprises:
logic configured to compare a list of elements used in building the target object with a list of target object dependencies declared in the makefile.

15. The system of claim 14, wherein the logic configured to determine if a disparity exists between the elements used in building the target object and the identified dependencies comprises:
logic configured to determine whether all elements used in building the target object correspond to target object dependencies declared in the makefile; and
logic configured to determine whether all target object dependencies declared in the makefile correspond to elements used in building the target object.

16. The system of claim 10, wherein the processor comprises:
logic configured to use respective unique identifiers within the build environment to identify a version of each element used in building the target object.

17. The system of claim 16, wherein the logic configured to determine if a disparity exists between the elements used in building the target object and the identified dependencies comprises:
logic configured to determine whether a version of each element used in building the target object matches a version of a corresponding target object dependency declared in the makefile using the respective identifiers.

18. The system of claim 17, wherein the logic configured to report existing disparities between the determined elements and the identified dependencies comprises at least one of:
logic configured to report elements used in building the target object that do not correspond to target object dependencies declared in the makefile as implicit dependencies;
logic configured to report target object dependencies declared in the makefile that do not correspond to elements used in building the target object as over-declared dependencies; and
logic configured to report when a version of any element used in building the target object does not match a version of a corresponding target object dependency declared in the makefile.

19. The system of claim 10, wherein the logic included in the processor is responsive to a switch associated with an executable program for building the target object using the makefile.

20. The system of claim 10, wherein the existing disparities between the determined elements and the identified dependencies are reported in at least one of a file stored in the memory and a warning displayable on a computer screen included in the system.

21. A computer readable medium containing a computer program for verifying the accuracy of a makefile associated with building a target object, wherein the computer program comprises executable instructions for:
identifying dependencies for building the target object based on information included in the makefile;
determining elements used in building the target object;
determining whether a disparity exists between the elements used in building the target object and the identified dependencies; and
reporting existing disparities between the determined elements and the identified dependencies.

22. The computer readable medium of claim 21, wherein the executable instructions for identifying dependencies for building the target object comprise instructions for:
parsing the makefile to identify the target object; and
recursively identifying dependencies of the target object declared in the makefile to create a list of declared target object dependencies.

23. The computer readable medium of claim 21, wherein the executable instructions for determining elements used in building the target object comprise instructions for:
identifying elements referenced or created during the building of the target object when the elements are referenced or created to create a list of elements used in building the target object.

24. The computer readable medium of claim 23, wherein the executable instructions for determining elements used in building the target object comprise instructions for:
identifying elements referenced or created while building a subcomponent used in building the target object;
associating the elements identified while building the subcomponent with the corresponding subcomponent; and
including the elements associated with the subcomponent in the list of elements when the subcomponent is used in building the target object

25. The computer readable medium of claim 21, comprising executable instructions for:
comparing a list of elements used in building the target object with a list of target object dependencies declared in the makefile.

26. The computer readable medium of claim 25, wherein the executable instructions for determining whether a disparity exists between the elements used in building the target object and the identified dependencies comprise instructions for:
determining whether all elements used in building the target object correspond to target object dependencies declared in the makefile; and
determining whether all target object dependencies declared in the makefile correspond to elements used in building the target object.

27. The computer readable medium of claim 21, comprising executable instructions for:
using respective unique identifiers to identify a version of each element used in building the target object.

28. The computer readable medium of claim 27, wherein the executable instructions for determining whether a disparity exists between the elements used in building the target object and the identified dependencies comprise instructions for:
determining whether a version of each element used in building the target object matches a version of a corresponding target object dependency declared in the makefile using the respective identifiers.

29. The computer readable medium of claim 21, wherein the executable instructions for reporting existing disparities between the determined elements and the identified dependencies comprise instructions for at least one of:
reporting elements used in building the target object that do not correspond to target object dependencies declared in the makefile as implicit dependencies;
reporting target object dependencies declared in the makefile that do not correspond to elements used in building the target object as over-declared dependencies; and
reporting when a version of any element used in building the target object does not match a version of a corresponding target object dependency declared in the makefile.

30. A system for verifying the accuracy of a makefile associated with building a target object, the system comprising:
a build environment including the makefile and other information for building the target object;
means for identifying dependencies within the build environment for building the target object;
means for determining elements included in the build environment used in building the target object;
means for comparing the elements used in building the target object with the identifying dependencies; and
means for reporting disparities between the elements used in building the target object and the identified dependencies.
